(19) United States
(12) Patent Application Publication
(10) Pub. No.: US 2020/0009560 A1
(43) Pub. Date: Jan. 9, 2020

(54) Filter Device

(71) Applicant: Stat Peel AG, Glarus (CH)

(72) Inventors: Krzysztof Krasnopolski, Alpnach (CH); David Schmid, Untervaz GR (CH); Burcu Celikkol Zijlstra, Zurich (CH); Joanna Borek-Donten, Zurich (CH); Ruedi Bieri, Glarus (CH)

(21) Appl. No.: 16/486,676

(22) PCT Filed: Feb. 2, 2018
(86) PCT No.: PCT/EP2018/052710

§ 371 Date: Aug. 16, 2019

(30) Foreign Application Priority Data
Feb. 17, 2017 (EP) 17156685.4

(51) Int. Cl. B01L 3/00; G01N 1/22; G01N 15/06; B01L 9/00

(52) U.S. Cl. CPC B01L 3/502753; G01N 1/2205; G01N 1/2273; G01N 15/0625; B01L 9/527; B01L 2200/027; G01N 2015/0038; B01L 2300/0681; B01L 2300/0816; G01N 2001/2223; G01N 2001/2276; G01N 2001/2288; B01L 2200/0647

(57) ABSTRACT

A filter device for filtering nano particles conveyed in a fluid in order to determine an exposure of the filter device to nano particles includes a support element having a top surface, a bottom surface, a lateral surface, and at least one fluid duct having a fluid inlet and a fluid outlet. The top surface and the bottom surface extend substantially parallel to each other. The filter device further includes at least one filter element with a collection surface on which the nano particles are to be deposited. The at least one filter element is arranged in the at least one fluid duct for collecting the nano particles conveyed in the fluid. The collection surface of the at least one filter element is oriented parallel to at least one of the top surface and the bottom surface.

### TECHNICAL FIELD

The present invention relates to a filter device for filtering particles, in particular nano particles, conveyed in a fluid in order to determine the exposure of the filter device to nano particles according to claim 1, to a receiving unit for such a filter device according to claim 13 and a collection device with a receiving unit according to claim 15 and to a system according to claim 16.

### PRIOR ART

WO 2016/150991 of the applicant discloses a collection device for collecting nano particles conveyed in a fluid in order to determine the exposure to nano particles. The device according to WO 2016/150991 can be for example worn by user that works in an environment in which nano particles are present.

### SUMMARY OF THE INVENTION

The object of the present invention is to provide a filter device which is compact in terms of size. In particular it is an object to provide a filter device for the use in the collection device according to WO 2016/150991.

This object is solved by the filter device according to claim 1. Accordingly a filter device for filtering nano particles conveyed in a fluid in order to determine the exposure of the filter device to nano particles, comprises
a support element having a top surface, a bottom surface, a lateral surface and at least one fluid duct having a fluid inlet and a fluid outlet, wherein the top surface and the bottom surface extend substantially parallel to each other, and
at least one filter element with a collection surface on which the nano particles will be deposited which filter element is arranged in said fluid duct for the collection of nano particles conveyed in said fluid.

The collection surface of the at least one filter element is oriented parallel to the top surface and/or the bottom surface. Furthermore is arrangement is also advantageous in terms of a scanning process of the collection surface when analyzing the amount of nano particles that have been collected.

Due to the orientation of the filter element parallel to the top surface and the bottom surface it is possible to provide the support element as a rather flat structure. This means that the lateral surface which extends between the top surface and the bottom surface can be provided with a small dimension as seen perpendicular to the top surface and the bottom surface.

The term nano-particles is to be understood as including particles having a size of 1 Nanometer to 20 micro meter.

The term nano particles includes but is not limited to at least one or a combination of the following: carbon nano tubes and/or carbon nano fibers and/or carbon nanoplatelets and/or PM 2.5 and other nanotubes and nanofibers. The term fluid refers preferably to air or any other fluid.

Preferably the filter element is arranged in a filter chamber that is part of fluid duct and that is delimited by sidewalls and a bearing surface on which the filter element is arranged. The bearing surface is oriented parallel to the top surface and/or the bottom surface.

The filter lies on the bearing surface and the sidewalls provide a stop against a movement of the filter element lateral to the bearing surface. The sidewall preferably encompasses the bearing surface in view of its circumference preferably completely and is preferably oriented perpendicularly to the bearing surface.

Preferably the filter element is held in the filter chamber by an adhesive bonding connection or by a mechanical connection or by a clamping connection.

The filter element or the collection surface, respectively, has preferably a rectangular or quadratic shape when viewed perpendicular to the collection surface. Thereby the edge length of the rectangle or the square is much larger than the thickness of the filter element.

In a first preferred embodiment the bearing surface is perpendicular to the fluid flow and faces the fluid duct in direction of fluid flow or is arranged away from the fluid flow. Thereby the fluid flows through an opening in the bearing surface which opening is covered by the filter element.

In a second preferred embodiment the bearing surface is parallel to the fluid flow. Thereby the fluid passes the filter element in an overflowing manner.

Both embodiments are advantageous of provide good results in terms of deposition of the nano particles on the filter element.

In the first preferred embodiment the filter element is arranged such that the fluid will flow through the collection surface. This means that the fluid actually crosses the filter element.

In a first variant of the first embodiment the fluid duct opens out into the filter chamber via its sidewall. Thereby the bearing surface is arranged at a distance with regard to the fluid duct such that the filter element can be place on the bearing surface. The bearing surface in this case comprises an opening such that the fluid duct will be continued to the fluid outlet.

In the second variant of the first embodiment the fluid duct opens out into the filter chamber via an opening crossing the bearing surface. Via this opening the filter element will be feed with the fluid. The bearing surface in this case is directed towards the fluid opening.

In the second preferred embodiment the filter element is arranged such that the fluid will overflow the collection surface, wherein the fluid duct is arranged adjacent to the filter chamber such that the fluid overflows the filter chamber and the filter element that is arranged in the filter chamber. In particular the filter chamber provides an extension of the fluid duct.

In all the mentioned embodiments it is preferable that the filter chamber has a depth along the sidewall which is much smaller than the width or the length of the filter chamber, whereby the depth is defined as being the direction perpendicular to the top surface and the bottom surface.

In the first embodiment width, length and depth of the filter chamber are preferably designed such that the filter element can be placed fully within the filter chamber.

In the second embodiment width, length and depth of the filter chamber are preferably designed such that the filter element can extend from the filter chamber at least partly into the cross-section of the fluid duct. In particular the collection surface or parts of the collection surface extend into the fluid duct.

In the first embodiment the fluid inlet is arranged in the lateral surface and the fluid outlet is arranged in the bottom surface, whereby the fluid duct will be diverted by a diversion with an angle that is preferably a 90° angle, wherein the filter element is preferably arranged between the diversion and the fluid outlet. This arrangement allows minimizing the distance between the top surface and the bottom surface further, whereby a good flow of the fluid through the filter element is maintained.

In the second embodiment the fluid inlet is arranged in the lateral surface and the fluid outlet is arranged in the bottom surface, whereby the fluid duct will be diverted by a diversion with an angle that is preferably a 90° angle, wherein the filter element is preferably arranged between the fluid inlet and the diversion. As with the first embodiment this arrangement allows minimizing the distance between the top surface and the bottom surface further, whereby a good flow of the fluid over the collecting surface of the filter element is maintained.

Preferably in all of the embodiments at least some of the surfaces limiting the fluid duct or at least the surfaces of the support element delimiting the fluid duct are at least partly provided with electrically conductive properties.

In particular the support element is made out of a metallic material, such as aluminum for example. Alternatively it is possible to add a respective electrically conductive coating to the surfaces of the support element delimiting the fluid duct.

The electrical conductive coating is advantageous, as it could be prevented that the fluid charges the support elements, impacting the nanoparticle flow in the channels.

Preferably in all of the embodiments at least in the region of the filter element a transparent element is provided such that the regions above the filter element are transparent. The transparency of said regions allow a visible analysis of the collecting surface in order to determine the amount of nano particles deposited on the collecting surface.

Alternatively the filter duct is delimited by sidewalls provided by the support element, wherein above of the filter chamber a pocket extends from the top surface into the support element, wherein in said pocket said transparent element is arranged. In other words: The transparent element is provided as an insert which is arranged in the pocket extending from the top surface into the support element above the filter chamber. Preferably said pocket has at least the same cross-section as the filter chamber as viewed from the top surface or said pocket has a slightly larger cross-section as the filter chamber as viewed from the top surface. In this variant preferably one transparent element is arranged per filter element.

Preferably the fluid duct is provided by grooves extending from the top surface into the support element, wherein the grooves are covered by a transparent element, which transparent element extends substantially over the whole top surface or a substantial part of the top surface. The fluid duct is thereby partly limited by the sidewalls provided by the grooves in the support element and by the surface of the transparent element.

Preferably the transparent element is in a plane contact with the top surface of the support element.

In a particularly preferred embodiment the top surface is provided with a rim extending from the top surface and at least partly around the top surface whereby the rim delimits a pocket in which the transparent element can be placed.

Preferably the transparent element is made of fused silica glass or borosilicate glass or cyclo olefin polymer (COP) or cyclo olefin copolymer (COC).

Preferably the transparent element is in particular for a laser light with a wavelength in the range of 514 to 785 nanometer, in particular 532 and 638 nm nanometer, transparent. Through said transparent element the nano particles that are deposited on or in said filter element can be analyzed.

Preferably the transparent element is mounted by means of a glued connection or greased connection or a clamping connection to the top surface.

In particular the transparent element is mounted fluidly tight to the top surface.

Preferably the filter element has a size that is smaller than a cuboid with lateral lengths of 100×40×5 Millimeters or with lateral lengths of 75×25×1.5 Millimeters.

Preferably the cross-section of the fluid duct is between 0.2 mm\hat{ }2 and 0.8 mm\hat{ }2 or between 0.3 mm\hat{ }2 and 0.7 mm\hat{ }2 or 0.4 mm\hat{ }2.

Preferably the filter device as viewed perpendicular to the top surface is substantially rectangular having a long side and a short side.

The following are optional, but preferred structural elements of the rectangular form of the filter device:
the edges of the rectangle are beveled; and/or
the at least one of the long sides comprise a recess to position the filter device in a receiving bay; and/or
at least one of the long sides comprises at least one tilted positioning edge, preferably at least two tilted positioning edges in the shape of triangular cutout extending through the filter element.

The following are further optional features of the filter device or the filter element, respectively:

As mentioned the filter element comprises a collection surface. Additionally the filter element may comprise an enhancement structure which enhancement structure is arranged in connection with said collection surface. If the collection surface is present, said nano particles are deposited in the region of said collection surface and said enhancement structure. The collection surface with the enhancement structure enhances the spectral properties of said nano particles for enabling a facile analysis of the amount of collected nano particles.

Due to this enhancement structure the analysis of the amount of collected nano particles becomes easier in that the distinction between the nano particles that are of particular interest and other particles becomes easier.

The enhancement structure is preferably part of the collection surface. The collection surface can be provided as geometrically defined surface or as a geometrically un-defined surface in which the surface is provided by random structure.

The term in the region of said collection surface and said enhancement structure is preferably to be understood that the particles can be deposited on the surface of the collection element or in the vicinity of the collection element or that the particles can be deposited at least partly within the filter device.

Preferably said collection surface and said enhancement structure is designed for surface enhanced Raman scattering such that nano particles can be detected by Raman spectroscopy. The enhancement structure is there preferably SERS-active.

In a first embodiment the enhancement structure comprises edges which are arranged in a plane provided by a surface or said collection surface of said collection element. The edges and the plane provided a geometrically defined structure.

Preferably in said first embodiment the filter element is a filter plate having a plurality of filter pores, wherein the margin of said opening provides said edge. Hence the edges are directly provided by the filter pores in said filter plate.

The filter pores can be cylindrical openings extending from a front side of the filter plate to a back side of the filter plate. Thereby the rim of the cylindrical opening in the front side provides said edge.

Preferably said filter pores are evenly distributed over an area of said filter plate which extends over the cross-section of the fluid duct. Preferably said area is congruent with the cross-section of the fluid duct leading to the filter plate.

Preferably the width of said filter pores is in the range of 20 to 900 nanometers, in particular in the range of 30 to 200 nanometers.

Preferably the density of said filters pores is in the range of 10⁸ to 10¹⁰ pores per square centimeter. The pores are preferably arranged in regular spaces to each other.

Preferably the filter element comprises a coating of a noble metal such as platinum or silver or gold or palladium. Said coating is arranged such that said nano particles are deposited at least partly on the coated regions. The coated regions are preferably,
the whole surface of the filter element, or
at least the collection surface of the filter element, or
at least the edges of the filter pores.

The coating has the advantage that spectroscopic differences between the nano particles and the other particles become enhanced.

Preferably the material of the filter plate Silicon nitride (SiN) or Silicon (Si) or Alumina or porous silicon.

In a second embodiment the filter element is filter membrane comprising said enhancement structure. The filter membrane is provided as a geometrically un-defined surface in which the surface is provided by random structure. The filter membrane can be provided by a non-woven or a woven structure.

Preferably said enhancement structure according to the second embodiment is arranged on a surface of the filter membrane. Alternatively the enhancement structure can also be embedded in said filter membrane.

Preferably said filter membrane is at least partly coated with nano particles of a noble metal such as platinum or silver or gold or palladium. The noble metal particle coating has the same effect as mentioned with regard to the first embodiment. The coating is preferably provided in that the noble metal particles are sprayed, dipped or deposited onto the filter membrane. Thereby the coating is provided on the surface of the filter membrane.

Preferably the material of the filter membrane is polycarbonate and/or mixed cellulose ester and/or polytetrafluoroethylene, etc.

Preferably the filter device according to all embodiments further comprises a reference section on which a determined reference or calibration information is placed. This information can be used when determining the amount of nano-particles.

A receiving unit for a filter device according to the description above is characterized in that the receiving unit comprises a reception bay with a bottom wall, a positioning wall extending from said bottom wall and a spring element which is configured to press the filter device against the bottom wall.

Preferably the receiving unit is further characterized
in that the positioning wall comprises a reception opening through which the filter device can be placed into the receiving bay; and/or
in that at least one stop element is arranged preferably in the vicinity of the reception opening, whereby the stop element serves as stop for the filter element against a movement out of the reception bay; and/or
in that the reception bay comprises positioning elements which serve to position the filter device in the reception bay; and/or
in that the bottom wall comprises at least one opening which is arranged such that
the at least one fluid outlet matches with its position with the opening, wherein the opening is surrounded with a sealing structure.

A collection device for collecting nano particles conveyed in a fluid in order to determine the exposure of the collection device to nano particles, wherein said collection device comprises a filter device as described above an a receiving unit as described above, wherein the collection device comprises further, a fluid propelling element propelling said fluid through the fluid duct of the filter device.

Preferably the collection device is provided exclusively for the collection of the nano particles but not for determining the amount of collected nano particles. This means that the collection device comprises the means to collect the nano particles, but does not comprise means to analyse the nano particles. In more detail, the collection device does not comprise a spectrometer or the like to determine the amount of nano particles. The spectrometer or the like is separate from the collection device.

In other words: The collection device is preferably provided as a carry-on device which can be carried by a user in a polluted or possibly polluted area. Thereby the collection device continuously collects the nano particles, in particular while the person remains in such an area. Even more preferably the collection device is provided as a personal carry-on device.

As it will be clear from the description herein the collection device is preferably part of a system. The system comprises the collection device and a spectrometer which is separate from the collection device. The collection device serves to collect the nano particles and the spectrometer serves to determine the amount of nano particles as collected by the collection device.

It is an advantage that the collection device is provided without the means to analyse the nano-particles, but with the means to collect the same, since the step of analyzing or determining the amount of the collected nano particles can be done with a separate spectrometer as it is outlined below. This means that on the one hand that the results will become more accurate since an enhanced spectrometer can be used compared with devices having a built-in spectrometer and on the other hand that the costs for the collection device can be reduced since no built-in spectrometer has to be provided.

The fluid propelling element is preferably a pump. The volumetric flow rate of the pump is preferably between 1 and 1100 ml/min.

The collection device is preferably provided such that the user can carry it when being exposed to a polluted environment. Hence the collection device is preferably light weight and has a relatively small size. In terms of size it is preferably smaller than 15 centimeters over its maximal dimension.

Preferably the collection device comprises in its fluid duct a pre-filter arrangement that is arranged ahead of said filter element as seen in direction of flow of said fluid. With the pre-filter arrangement it can be prevented that particles are deposited on the collection element which are not nano particles.

The filter device is separate from the collection device but is connectable to or insertable into the collection device. The filter device can be replaced after the collection of nano particles with a new filter element, whereby the used filter device can be disposed. Via a fluid duct interface the parts of the fluid duct of the filter device are connected to the parts of the fluid duct of the collection device.

Preferably the collection device comprises further a battery with which at least said fluid propelling element is powered.

Preferably all the components as described herein with regard to the collection device are arranged on a common support plate. The support plate is preferably part of a housing in which, as mentioned above, comprises also the window.

Furthermore it is also possible to arranged additional elements in said housing such as a chip for further functions, such as storing data, measuring the collection time or the time in use, controlling the pump, etc.

Furthermore the collection device may comprise an accelerometer, and/or a thermometer and/or a hydrometer to monitor further data. Furthermore in terms of communication the collection device may comprise a wireless chip to provide communication functions and/or enables to determine the location of the collection device. The wireless chip can be a WLAN or Bluetooth module.

The accelerometer can for example be used to detect the physical activity of the user and to control the pump accordingly. This means, that if the physical activity of the user is high, the volumetric flow rate will also be high if the physical activity of the user is low, the volumetric flow rate will also be low. Therefore the air intake into the collection device is approximately to scale with the air intake into the lung of the carrier of the collection device.

With the thermometer and/or the hydrometer it is also possible to gain further information about the location or the use of the collection device. For example it is possible to detect, if the user is at its workplace or having a break outside.

Preferably the collection device comprises a gas detector. With the gas detector it is possible to determine the properties of the gas surrounding the collection device. For example it becomes possible to determine, if the collection device is in an environment in which nano particles occur, or if it is in another environment.

Based on the position of the collection device that can be determined by using data provided by the sensors as mentioned above, the fluid propelling element can be controlled and/or the collection device can be switched on or off. For example: In case the collection device is in a room in which nano particles are present the collection device will be switched on or the volumetric flow rate of pump will be increased. In case the collection device leaves the room to an environment in which only an uncritical amount of nano particles exists the collection device will switch off or the volumetric flow rate of pump will be decreased.

A system comprising a collection device according to the description above and a gripping tool, whereby the gripping tool comprises at least one gripping arm which is configured to grasp parts of said filter device in order to insert and/or to remove the filter device from the reception bay.

Preferably within said reception bay said fluid duct interface is arranged via which the parts of the fluid duct of the filter device is connected to the parts of the fluid duct of the collection element.

Preferably the system comprises further a spectrometer. The filter device can be placed in said spectrometer which then analysis the collection element in terms of the amount of nano particles present on said surface. Alternatively a transmission electron microscopy device can also be used.

Preferably Raman spectroscopy is used to operate the spectrometer. This is particularly advantageous in combination with the enhanced surface structure.

As described above the filter device is separate from the spectrometer and is insertable into the spectrometer in order to analyze the amount of collected nano particles.

Preferably the gripping tool lifts said filter device such that the filter device is removable from the receiving unit.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a bottom view of the filter device according to the present invention;

FIG. 2 shows a side view of the filter device according to FIG. 1;

FIG. 3 shows a top view of the filter device according to FIG. 1;

FIG. 4 shows a perspective view of the filter device according to FIG. 1;

FIG. 5 shows a cross-section perpendicular to a filter duct through the filter device according to a first variant of a first embodiment;

FIG. 6 shows a cross-section along the filter duct through the filter device according to a first variant of a first embodiment;

FIG. 7 shows a cross-section perpendicular to a filter duct through the filter device according to a second variant of a first embodiment;

FIG. 8 shows a cross-section along the filter duct through the filter device according to a second variant of a first embodiment;

FIG. 9 shows a cross-section along the filter duct through the filter device according to a second embodiment;

FIG. 10 shows a perspective view of a collection device with a receiving unit for the reception of the filter device, whereby the filter device is not inserted;

FIG. 11 shows the view of FIG. 10 with the filter device;

FIG. 12 shows a side view of a gripping tool for inserting and/or removing the filter device into the collection device; and

FIG. 13 shows a top view of a gripping tool for inserting and/or removing the filter device into the collection device;

FIG. 14 shows an additional variant of the filter device according to the present invention; and

FIG. 15 shows a cross-section of the additional variant along line C-C.

### DESCRIPTION OF PREFERRED EMBODIMENTS

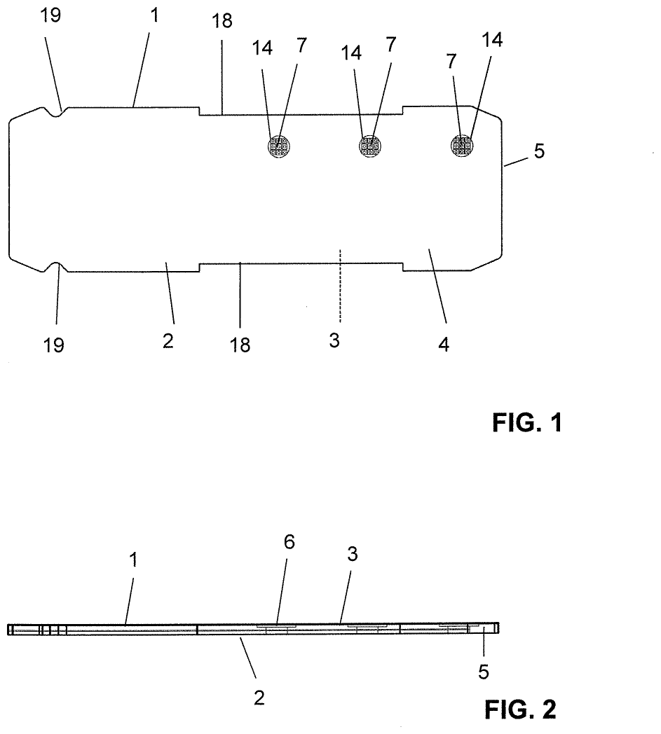

FIG. 1 shows a bottom view of a filter device 1 for filtering nano particles conveyed in a fluid in order to determine the exposure of the filter device 1 to nano particles. Such a filter device 1 can be used for example in a collection device according to WO 2016/150991.

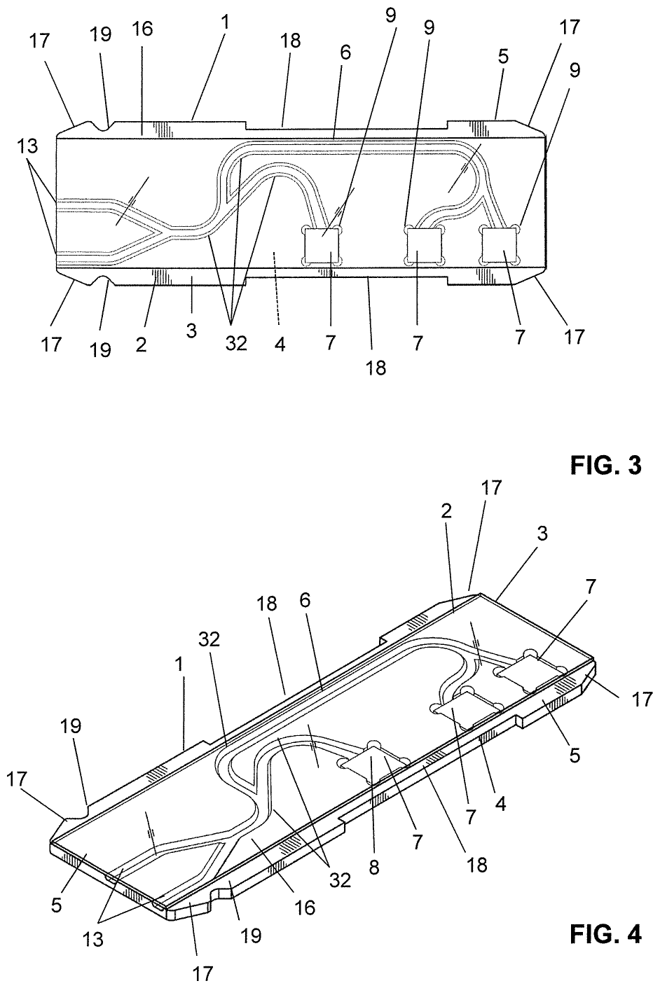

FIG. 2 shows a side view of the filter device 1. FIG. 3 shows a top view of the filter device 1 whereas FIG. 4 shows a perspective view from the top.

The filter device 1 according to the embodiment as shown in the figures comprises a support element 2 having a top surface 3, a bottom surface 4 and a lateral surface 5. The top surface 3 is oriented in a parallel manner with regard to the bottom surface 4. The lateral surface 5 links the top surface 3 with the bottom surface 4. Furthermore the support element 2 comprises at least one fluid duct 6 having a fluid inlet 13 and a fluid outlet 14. In the fluid duct 6 the fluid F which comprises the nano particles is conveyed.

Additionally the filter device 1 comprises at least one filter element 7 with a collection surface 8. On this collection surface 8 the nano particles will be deposited. The filter element 7 is arranged in the fluid duct 6 and collects therefore the nanoparticles conveyed in the fluid F. The collection surface 8 of the at least one filter element 7 is oriented parallel to the top surface 3 and/or the bottom surface 4.

In the present case three filter elements 7 are arranged each of which is feed a fluid duct 6 whereby over some portions there is a common section in which some of or all of the fluid ducts 6 are combined. However, the fluid ducts 6 are arranged such that each of the three filter elements 7 is served with individual part of the fluid duct.

As mentioned the fluid ducts 6 comprise several sections which are linked to each other additionally there are arranged several curves 32 which serve as separating means such that the particle conveyed in the fluid duct 6 will be separated in respective sections of the fluid duct 6. In the present case there are two fluid inlets 13 and three fluid outlets 14, whereby the fluid duct 6 is diverted according to the fluid duct sections. The radius of said curves is provided such that particles to be collected are separateable from other particles which are not of interest and wherein at least one of said exit is directed towards collection element.

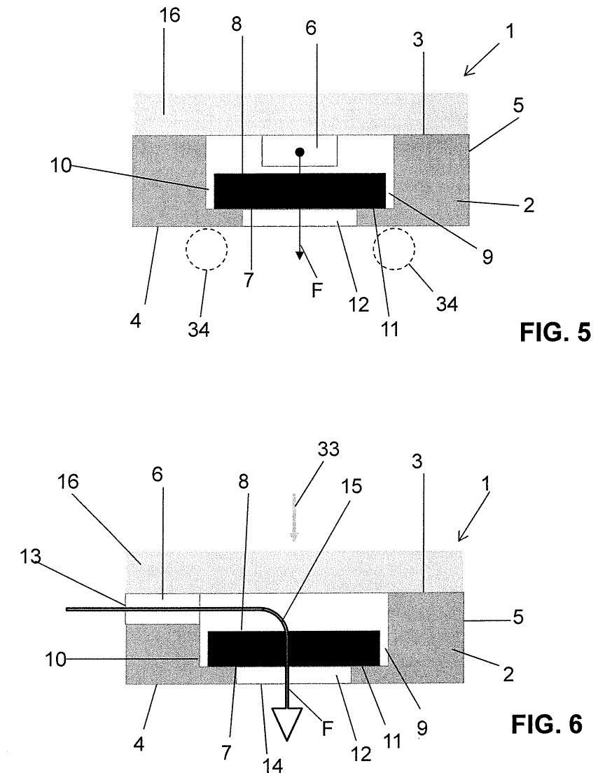

FIGS. 5 to 9 show various cross sections through the filter element.

FIGS. 5 and 6 show a first variant of a first embodiment of the filter device 1. FIG. 5 shows a cross section through the filter device 1 for filtering nanoparticles in a direction perpendicular to the fluid duct 6. FIG. 6 shows a cross section along the fluid duct 6.

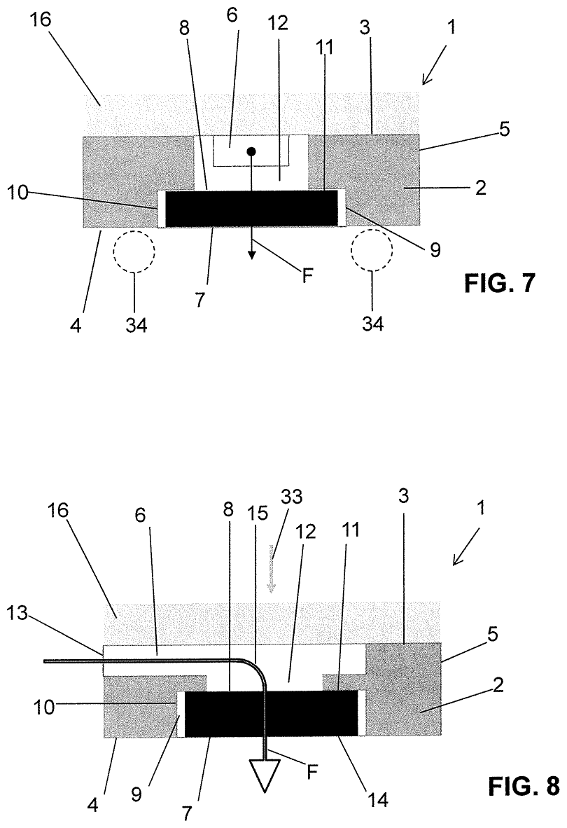

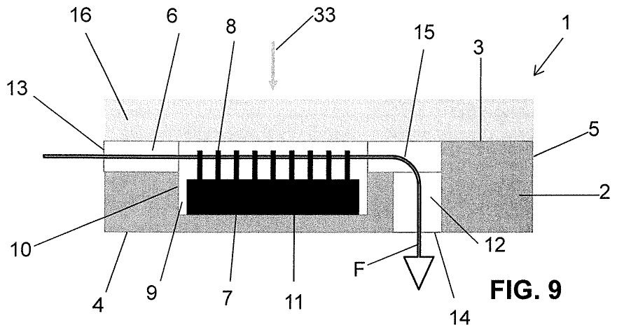

FIGS. 7 and 8 show a second variant of the first embodiment of the filter device 1. FIG. 7 shows a cross section through the filter device 1 for filtering nanoparticles in a direction perpendicular to the fluid duct 6. FIG. 8 shows a cross section along the fluid duct 6.

FIG. 9 shows a second embodiment of the filter device 1 according to the present invention.

In the following reference is made to FIGS. 5 to 9 and the respective features will be described.

In all of the embodiments the filter element 7 is arranged in a filter chamber 9 that is part of the fluid duct 6. The filter chamber 9 is delimited by sidewalls 10 and a bearing surface 11. The filter element 7 is placed or arranged on the bearing surface 11. The bearing surface 11 is thereby oriented parallel to the top surface 3 and/or to the bottom surface 4. In all the embodiments the bearing surface is arranged in the support element 2 between the top surface 3 and the bottom surface 4.

Preferably the filter element 7 is held in the filter chamber 9 by an adhesive connection. Other connections are also possible.

The filter element 7 has preferably the shape of a quadratic or rectangular filter membrane with a thickness that is much smaller than the extension of the filter element 7 perpendicular to the thickness.

In the first variant of the first embodiment according to FIGS. 5 and 6 the bearing surface 11 faces the fluid duct 6 in direction of fluid flow. This means that on the bearing surface 11 the filter element 7 is located and the fluid passes the filter element 7 through itself and passes then the bearing surface 11. The bearing surface 11 comprises an opening 12 through which the fluid can flow.

In FIGS. 5 and 6 the fluid flow is indicated by means of arrow F.

In the second variant of the first embodiment which is showed in FIGS. 7 and 8 the bearing surface 11 is arranged such that it is arranged in direction away from the fluid flow. This means that the fluid passes the opening 12 before it is actually entered into the filter element.

In the second embodiment according to FIG. 9 the bearing surface 11 is arranged parallel to the fluid flow F. This means that the fluid flow F does not cross the bearing surface but follows in a parallel direction to the bearing surface 11 at a distance over the bearing surface 11.

In the first embodiment according to FIGS. 5 to 8 the filter element 7 is arranged such that the fluid will flow through the collection surface 8. In the first variant according to FIGS. 5 and 6 the fluid duct 6 opens out into the filter chamber 9 via its sidewall and in the second variant according to FIGS. 7 and 8 the fluid duct 6 opens out into the filter chamber via an opening crossing the bearing surface 11.

In the second embodiment according to FIG. 9 the filter element 7 is arranged such that the fluid will overflow the collection surface 8 of the filter element 7. Thereby the filter element 7 is arranged such that it extends from the filter chamber 9 slightly into the fluid duct 6. The fluid duct 6 is thereby arranged relative to the filter chamber 9 such that the fluid overflows the filter chambers 6. Furthermore the fluid overflows the filter element 7 that is arranged in the filter chamber 9.

In all of the embodiments the filter chamber 6 has a depth along the sidewall which is not smaller than the width or the length of the filter chamber. The depth is defined as being the direction perpendicular to the top surface and the flow surface.

In the first embodiment the fluid inlet 13 is arranged in the lateral surface 5 and the fluid outlet 14 is arranged in the bottom surface 4. It can be seen that the fluid duct will be diverted by a diversion 15 with an angle that is preferably a 90° angle. The filter element 7 is preferably arranged between the diversion 15 and the fluid outlet 14.

In the second embodiment according to FIG. 9 the fluid inlet 13 is arranged also in the lateral surface 4 and the fluid outlet 14 is arranged in the bottom surface 4. Thereby the fluid duct is also diverted by a diversion 15 with an angle that is preferably a 90° angle. The filter element 7 however is arranged between the fluid inlet 13 and the diversion 15.

In all the embodiments the overall extension of the filter element 7 is such that the larger surfaces of the filter element 7 are parallel to the top surface and the bottom surface.

Preferably at least some of the surfaces which limit the fluid duct 6 are at least partly provided with electrically conductive properties. This can be achieved by either a conductive electrically coating on the sidewalls of the fluid duct 6 or by providing the support element 2 out of a metallic material.

For analysing the nanoparticles that are deposited on the filter element 7 a transparent element 17 is provided in the regions above the filter element 7 such that these regions become transparent. Thereby it will be possible to analyse the collection surface 8 by means of a laser. This is shown with arrow 33.

In the present case it is most preferably that the transparent element 16 extends substantially over the whole top surface 3. Such a variant is shown in FIGS. 1 to 9. Thereby the transparent element 16 serves as limiting element for the fluid duct. In the present case the fluid duct 2 is provided by grooves 17 extending from the top surface 3 into the support element 2. The groves 17 are then covered by the transparent element 16. The transparent element 16 extends, as mentioned, substantially over the whole top surface 3. In other embodiments the transparent element 16 extends over a substantial part of the top surface 3.

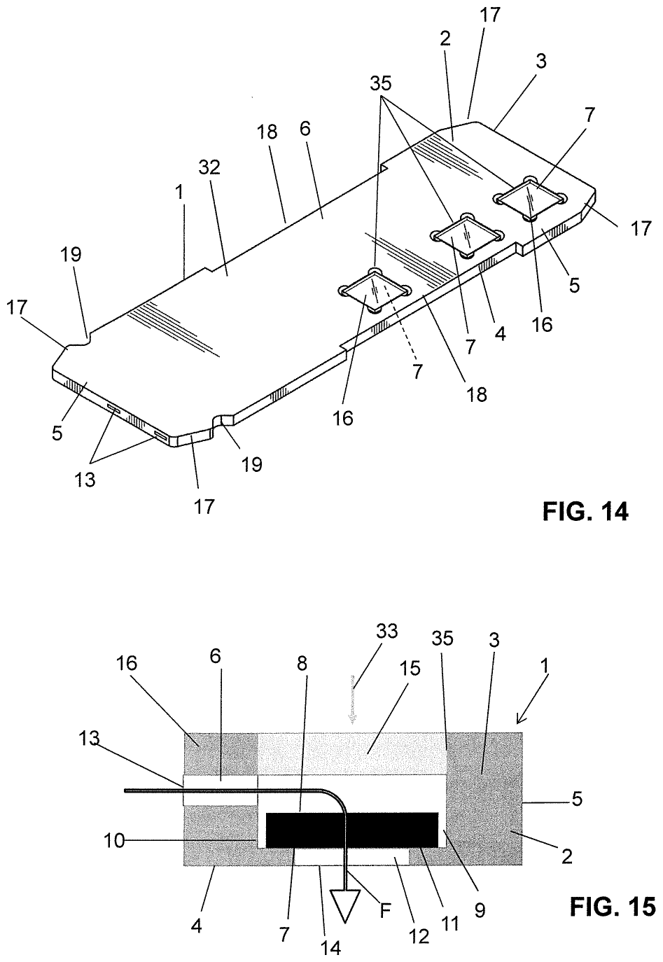

FIGS. 14 and 15 show an additional variant of the arrangement of the transparent element 15. Same features are designated with the same reference numerals and reference is made to the description above. In particular the filter element could also be arranged as shown in FIGS. 7 and 8. In this additional variant there is for each of the filter elements 7 one transparent element 15 arranged. In the present case three filter elements 7 and accordingly three transparent elements 15 are arranged. The transparent element 15 is thereby arranged in a pocket 35 extending from the top surface 3 of the support element 2 into the support element 2. The pocket 35 is arranged above the filter chamber 9 and has at least the same extension as the filter chamber 9. In each of the corner of the pocket there is arranged a cavity in order to enhance the positioning process of the transparent element 15 in the pocket 35. The filter element 7 is thereby arranged in said pocket 35 by means of a glued or a mechanical connection. In this variant the fluid duct 6 as such is provided by means of sidewalls 10 which are part of the support element 2. In the region of the filter chamber 9 the fluid duct 6 is further delimited by means of said transparent element 15.

Preferably the transparent element 15 is made of fused silica glass, borosilicate glass, COP, COC, etc.

The transparent element is preferably mounted to the top surface 3 by means of an adhesive connection.

In particularly the transparent element 15 is arranged in a fluidly tight connection to the top surface 3.

The filter device 1 has a size that is smaller than a cuboid with lateral lengths of 100×40×5 Millimeters or with lateral lengths of 75×25×1.5 Millimeters and/or in that the cross-section of the fluid duct is between 0.2 mm\hat{ }2 and 0.8 mm\hat{ }2 or between 0.3 mm\hat{ }2 and 0.7 mm\hat{ }2 or 0.4 mm\hat{ }2.

The filter device 1 is as viewed perpendicular to the top surface 3 is substantially rectangular having a long side and a short side. Preferably the edges 17 of the rectangle are beveled. Preferably at least one of the long sides comprise a recess 18 to position the filter device 1 in a receiving bay and/or at least one of the long sides comprises at least one tilted positioning edge 19, preferably at least two tilted positioning edges 19 in the shape of triangular cutout extending through the filter element 1.

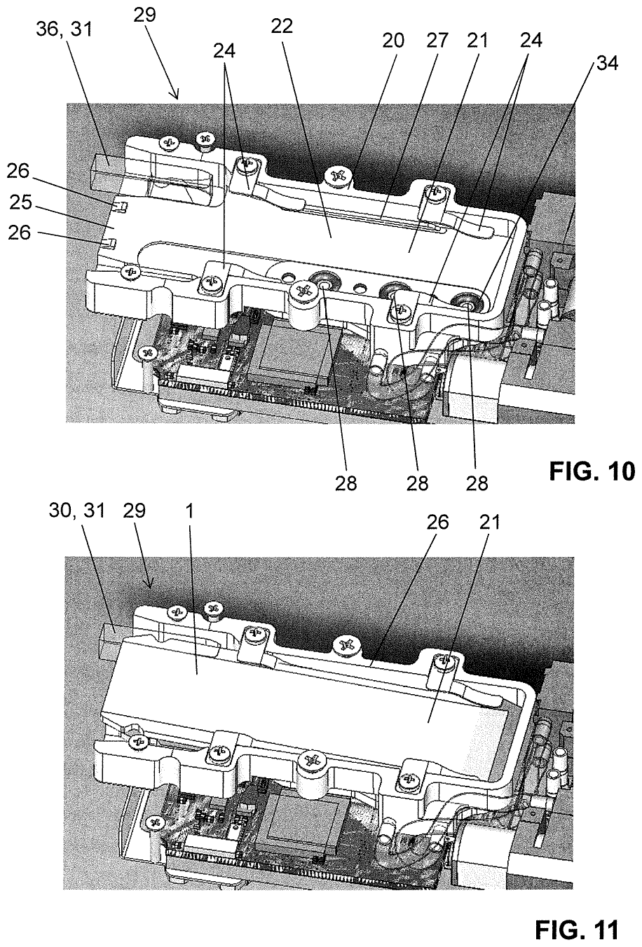

FIGS. 10 and 11 show a receiving unit 20 for a filter device 1 according to the description above. The receiving unit 20 is preferably part of a collection device 29 which is shown in parts in FIGS. 10 and 11.

The receiving unit 20 comprises a reception bay 21 with a bottom wall 22, a positioning wall 23 extending from that bottom wall 22 and a spring element 24 which is configured to press the filter device 1 against the bottom wall 22. In FIG. 10 it is shown that the bottom wall 22 comprises several openings 28 which are arranged such that the at least one fluid outlets 14 match with their position with the openings 28 thereby each of the openings 28 is surrounded by a sealing structure 34. The sealing structure 34 can be a sealing ring that extends around the respective opening 28.

From FIG. 10 in which the reception bay 21 is shown without the filter device 10 it can be seen that the reception bay comprises at least one stop element 26, here two stop elements 26 which are arranged in the vicinity of the reception opening 25. Thereby the stop element 26 serves as a stop for a filter element 7 against a movement out of the reception bay 21. Since the spring elements 24 press the filter device 1 down towards the bottom wall 22 the filter device 1 is in contact with the stop element 26 by means of the lateral surface 5.

Additionally the reception bay 21 comprises positioning element 27 which serve to position the filter device 1 in the reception bay 21. In the present case the positioning elements 27 have the shape of elongate extensions from the bottom wall 28. This elongate extensions extend into the recess 18 that is arranged at the filter device 1.

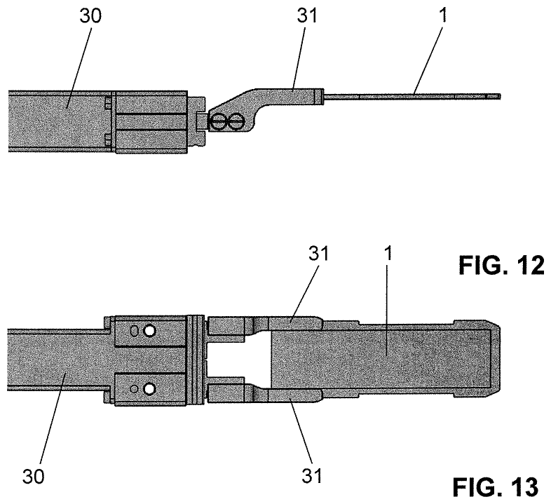

In FIGS. 12 and 13 a gripping tool 30 is shown. The gripping tool 30 is also schematically shown in FIGS. 10 and 11 with the gripping arm 31. The gripping tool 30 comprises at least one gripping arm 31 which is configured to grasp parts or that filter device 1 in order to insert and/or to remove the filter device 1 from the reception bay 21. The gripping tool 30 is shown in FIGS. 12 and 13 whereby it can be seen that two gripping arms 31 are arranged which grasp the filter device 1 on their sides.

The gripping tool 30 and its gripping arms 31 are provided such that the gripping arms lift the filter device in the reception bay against the spring pressures provided by spring element 24. Thereby the gripping tool lifts that filter device 1 such that the filter device 1 is removable from the reception bay and the receiving unit.

LIST OF REFERENCE SIGNS

| | |
|---|---|
| 1 | Filter device |
| 2 | support element |
| 3 | top surface |
| 4 | bottom surface |
| 5 | lateral surface |
| 6 | fluid duct |
| 7 | filter element |
| 8 | collection surface |
| 9 | filter chamber |
| 10 | sidewall |
| 11 | bearing surface |
| 12 | opening |
| 13 | fluid inlet |
| 14 | fluid outlet |
| 15 | diversion |
| 16 | transparent element |
| 17 | bevelled edges |
| 18 | recess |
| 19 | positioning edge |
| 20 | receiving unit |
| 21 | reception bay |
| 22 | bottom wall |
| 23 | positioning wall |
| 24 | spring element |
| 25 | reception opening |
| 26 | stop element |
| 27 | positioning elements |
| 28 | openings |
| 29 | collection device |
| 30 | gripping tool |
| 31 | gripping arm |
| 32 | curves |
| 33 | arrow |
| 34 | sealing structure |
| 35 | pocket |

1. A filter device for filtering nano particles conveyed in a fluid in order to determine an exposure of the filter device to nano particles, the filter device comprising:
a support element having a top surface, a bottom surface, a lateral surface, and at least one fluid duct having a fluid inlet and a fluid outlet, wherein the top surface and the bottom surface extend substantially parallel to each other, and
at least one filter element with a collection surface on which the nano particles are to be deposited, wherein the at least one filter element is arranged in said at least one fluid duct for collecting the nano particles conveyed in said fluid,
wherein a collection surface of the at least one filter element is oriented parallel to at least one of the top surface and the bottom surface.

2. The filter device according to claim 1, wherein the at least one filter element is arranged in a filter chamber that is part of the at least one fluid duct and that is delimited by sidewalls and a bearing surface on which the at least one filter element is arranged, and wherein the bearing surface is oriented parallel to at least one of the top surface and the bottom surface.

3. The filter device according to claim 2, wherein the at least one filter element is held in the filter chamber by an adhesive bonding connection or by a mechanical connection or by a clamping connection.

4. The filter device according to claim 2, wherein the bearing surface is perpendicular to the fluid flow, wherein the bearing surface faces the at least one fluid duct in a direction of fluid flow, or wherein the bearing surface is arranged in a direction away from the fluid flow, or wherein the bearing surface is parallel to the fluid flow.

5. The filter device according to claim 2,
wherein the at least one filter element is arranged such that the fluid will flow through the collection surface, wherein the at least one fluid duct opens out into the filter chamber via its sidewall, or wherein the at least one fluid duct opens out into the filter chamber via an opening crossing the bearing surface.

6. The filter device according to claim 1,
wherein the fluid inlet is arranged in the lateral surface and wherein the fluid outlet is arranged in the bottom surface, whereby the at least one fluid duct is diverted by a diversion with an angle, and wherein the filter element is arranged between the diversion and the fluid outlet.

7. The filter device according to claim 1, wherein at least some surfaces limiting the at least one fluid duct or at least surfaces of the support element delimiting the at least one fluid duct are at least partly provided with electrically conductive properties.

8. The filter device according to claim 1, wherein, at least in a region of the at least one filter element, a transparent element is provided such that regions above the at least one filter element are transparent.

9. The filter device according to claim 1, wherein the at least one fluid duct is provided by grooves extending from the top surface into the support element, wherein the grooves are covered by a transparent element that extends substantially over an entire top surface or a substantial part of the top surface, or wherein the at least one filter duct is delimited by sidewalls provided by the support element, wherein a pocket extends above a filter chamber from the top surface into the support element, and wherein the transparent element is arranged in said pocket.

10. The filter device according to claim 8, wherein the transparent element is made of fused silica glass, borocilicat glass, COP, COC, or wherein the transparent element is mounted by means of an adhesive connection to the top surface, or wherein the transparent element is mounted in a fluidly tight connection to the top surface.

11. The filter device according to claim 1, wherein the filter device has a size that is smaller than a cuboid with lateral lengths of 100×40×5 millimeters or with lateral lengths of 75×25×1.5 millimeters, or wherein a cross-section of the at least one fluid duct is between 0.2 mm and 0.8 mm or between 0.3 mm and 0.4 mm or 0.4 mm.

12. The filter device according to claim 1, wherein the filter device is, as viewed perpendicular to the top surface, substantially rectangular having a pair of long sides and a pair of short sides,
wherein edges of the rectangle are beveled; or
wherein the at least one of the long sides comprises a recess to position the filter device in a receiving bay; or
wherein at least one of the long sides comprises at least one tilted positioning shaped as a triangular cutout extending through the at least one filter element.

13. A receiving unit for a filter device according to claim 1, wherein the receiving unit comprises a reception bay with a bottom wall, a positioning wall extending from said bottom wall and a spring element which is configured to press the filter device against the bottom wall.

14. The receiving unit as claimed in claim 13,
wherein the positioning wall comprises a reception opening through which the filter device can be placed into the receiving bay, or
wherein at least one stop element is arranged preferably in the vicinity of the reception opening, whereby the at least one stop element serves as a stop for the at least one filter element against a movement out of the reception bay, or
wherein the reception bay comprises positioning elements to position the filter device in the reception bay, or
wherein the bottom wall comprises at least one opening which is arranged such that the at least one fluid outlet matches with its position with the at least one opening, wherein the at least one opening is surrounded with a sealing structure.

15. A collection device for collecting nano particles conveyed in a fluid in order to determine an exposure of the collection device to nano particles, the collection device comprising:
a filter device and a receiving unit,
wherein said filter device comprises a support element having a top surface, a bottom surface, a lateral surface, and at feast one fluid duct having a fluid inlet and a fluid outlet, wherein the top surface and the bottom surface extend substantially parallel to each other, and at least one filter element with a collection surface on which the nano particles are to be deposited, wherein the at least one filter element is arranged in said at least one fluid duct for collecting the nano particles conveyed in said fluid, wherein the collection surface of the at least one filter element is oriented parallel to at least one of the top surface and the bottom surface,
wherein the receiving unit comprises a reception bay with a bottom wall, a positioning wall extending from said bottom wall, and a spring element which is configured to press the filter device against the bottom wall, and
wherein the collection device further comprises a fluid propelling element for propelling said fluid through the at least one fluid duct of the filter device.

16. A system comprising a collection device according to claim 15 and a gripping tool, wherein the gripping tool comprises at least one gripping arm which is configured to grasp parts of said filter device in order to at least one of insert and remove the filter device from the reception bay.

17. The system according to claim 16, wherein the gripping tool lifts said filter device such that the filter device is removable from the receiving unit.

18. The filter device according to claim 2, wherein the at least one filter element is arranged such that the fluid overflows the collection surface, and wherein the at least one fluid duct is arranged adjacent to the filter chamber such that the fluid overflows the filter chamber and the at least one filter element that is arranged in the filter chamber.

19. The filter device according to claim 1, wherein the fluid inlet is arranged in the lateral surface and wherein the fluid outlet is arranged in the bottom surface, whereby the at least one fluid duct is diverted by a diversion with an angle of 90°, and wherein the at least one filter element is arranged between the fluid inlet and the diversion.

20. The filter device according to claim 9, wherein the transparent element is made of fused silica glass, borocilicat glass, COP, COC, or wherein the transparent element is mounted by means of an adhesive connection to the top surface, or wherein the transparent element is mounted in a fluidly tight connection to the top surface.
